(19) United States
(12) Patent Application Publication
(10) Pub. No.: US 2014/0149546 A1
(43) Pub. Date: May 29, 2014

(54) REMOTE COMMUNICATION SYSTEM FOR COMMUNICATION WITH COMPANION ANIMAL AND REMOTE COMMUNICATION METHOD WITH COMPANION ANIMAL USING THE SAME

(71) Applicant: Sang-Min HONG, Namyangju-si (KR)

(72) Inventor: Sang-Min HONG, Namyangju-si (KR)

(21) Appl. No.: 14/091,699

(22) Filed: Nov. 27, 2013

(30) Foreign Application Priority Data
Nov. 27, 2012 (KR) 10-2012-0135053

(51) Int. Cl. H04L 29/08

(52) U.S. Cl. CPC H04L 67/10
USPC 709/217

(57) ABSTRACT

Provided are a remote communication system for communication with a companion animal and a remote communication method with a companion animal using the same, wherein the breeder of a companion animal can easily check expression of an opinion according to a behavior pattern of the companion animal even at a remote place. To this end, the remote communication system with a companion animal includes a communication apparatus for collecting information about a behavior pattern of the companion animal and transmitting a message, configured by analyzing the collected information, over a wired/wireless network and a user terminal for receiving the message received from the communication apparatus over the wired/wireless network and outputting the received message.

### CROSS REFERENCE

The present application claims the benefit of Korean Patent Application No. 10-2012-0135053 filed in the Korean Intellectual Property Office on Nov. 27, 2012 the entire contents of which are incorporated herein by reference.

### BACKGROUND OF THE INVENTION

1. Technical Field

The present invention relates to a remote communication system with a companion animal and a remote communication method with a companion animal using the same, more particularly, to a remote communication system for communication with a companion animal and a remote communication method with a companion animal using the same, wherein the breeder of a companion animal can easily check expression of an opinion according to a behavior pattern of the companion animal even at a remote place.

2. Description of the Related Art

There are several problems in managing pet animals when persons who breed pet animals leave their houses empty because they spend a lot of time outside like other persons.

In particular, if a person leaves his or her house empty for a long time due to an outgo or a vacation, the supply of food is problematic. In order to solve this problem, persons who breed pet animals leaves their pet animals in paid care centers, but it is difficult to handle the pet animals because the pet animals have different tastes or eating habits.

Furthermore, there is a need for attention to a change of environments because animals are sensitive to a change of environments.

Accordingly, devices for supplying food to pet animals at home through the Internet at remote places are recently developed by taking the problems into consideration.

For example, techniques for monitoring the state of pet animals at a remote place and supplying video, sound, and feed to the pet animals were disclosed in Korean Patent Laid-Open Publication No. 2001-0067494 and Korean Patent Registration No. 10-0415155.

However, the techniques have a disadvantage in that a pet animal may do not eat if a breeder is busy or misses the supply of feed because the needs of the pet animal is never taken into consideration and the breeder supplies feed to the pet animal unilaterally when the breeder thinks of the pet animal.

For another example, a technique for checking the state of a pet animal at a remote place and performing an interaction between a breeder and the pet animal was disclosed in Korean Patent Registration No. 10-0703990.

This technique, however, has a disadvantage in that a breeder always carries an additional tool, that is, a controller, because the controller is necessary to control a toy vehicle with which a pet animal will play at a remote place. Furthermore, the technique has a disadvantage in that it is difficult to generate a continued interest of a pet animal because only one playing pattern can be provided to the pen animal.

### SUMMARY OF THE INVENTION

Accordingly, a first object of the present invention is to provide a remote communication system with a companion animal, which enables feeding, real-time monitoring, playing, and communication even at a remote place through the Internet so that even a single household who breeds a companion animal can carry on outside activities smoothly.

A second object of the present invention is to provide a remote communication method with a companion animal using the remote communication system with a companion animal.

Furthermore, a second object of the present invention is to provide a remote communication method with a companion animal, wherein the remote communication system for communication with a companion animal can be shared with an acquaintance designated by a breeder for multilateral remote communication with a companion animal.

In order to achieve the first object of the present invention, an embodiment of the present invention provides a remote communication system for communication with a companion animal, including a communication apparatus for collecting information about a behavior pattern of the companion animal and transmitting a message, configured by analyzing the collected information, over a wired/wireless network and a user terminal for receiving the message received from the communication apparatus over the wired/wireless network and outputting the received message.

Furthermore, in order to achieve the second object of the present invention, an embodiment of the present invention provides a remote communication method for communication with a companion animal that includes remote communication for communication, including a behavior pattern collection step of collecting, by a communication apparatus, information about a behavior pattern of the companion animal by sensing the behavior pattern, a message transmission step of generating, by the communication apparatus, an opinion expression message of the companion animal by analyzing the information about the behavior pattern and transmitting the generated opinion expression message to a user terminal over a wired/wireless network, and an message output step of outputting, by the user terminal, the opinion expression message received from the communication apparatus over the wired/wireless network.

Furthermore, in order to achieve the second object of the present invention, an embodiment of the present invention provides a remote communication method with a companion animal, including a behavior pattern collection step of collecting, by a communication apparatus, information about a behavior pattern of the companion animal by sensing the behavior pattern, a message transmission step of generating, by the communication apparatus, an opinion expression message of the companion animal by analyzing the information about the behavior pattern and transmitting the generated opinion expression message to a user terminal over a wired/wireless network, and an message output step of outputting, by the user terminal, the opinion expression message received from the communication apparatus over the wired/wireless.

Furthermore, in order to achieve the second object of the present invention, another embodiment of the present invention provides a remote communication method for communication with a companion animal, including a supporter configuration step of receiving, by a communication apparatus, information about a supporter terminal with which the companion animal is to be shared, a behavior pattern collection step of collecting, by the communication apparatus, information about a behavior pattern of the companion animal by sensing a behavior of the companion animal, a message transmission step of confirming, by the communication apparatus, an opinion expression message of the companion animal by analyzing the information about the behavior pattern and transmitting the confirmed opinion expression message to a user terminal, the supporter terminal, or both the user terminal and the supporter terminal over a wired/wireless network, and a message output step of outputting, by the user terminal or the supporter terminal or both the user terminal and the supporter terminal, the opinion expression message received from the communication apparatus over the wired/wireless network.

Furthermore, in order to achieve the second object of the present invention, yet another embodiment of the present invention provides a remote communication method for communication with a companion animal, including a supporter configuration step of receiving, by a communication apparatus, information about a supporter terminal with which a companion animal is to be shared, an auxiliary control step of accessing, by the supporter terminal, the communication apparatus over a wired/wireless network and inputting a control signal to the communication apparatus, and an auxiliary pattern output step of outputting, by the communication apparatus, a set pattern in response to the control signal.

### BRIEF DESCRIPTION OF THE DRAWINGS

FIG. 1 shows the construction of a remote communication system in accordance with an embodiment of the present invention;

FIG. 2 is a block diagram of a communication apparatus in accordance with an embodiment of the present invention;

FIG. 3 is a block diagram of a communication apparatus in accordance with another embodiment of the present invention;

FIG. 4 is an exploded perspective view of the communication apparatus in accordance with an embodiment of the present invention;

FIG. 5 is a schematic diagram illustrating an example in which the remote communication system of FIG. 1 is used;

FIG. 6 shows the construction of a remote communication system in accordance with another embodiment of the present invention; and

FIG. 7 is a flowchart illustrating a remote communication method in accordance with an embodiment of the present invention.

### DETAILED DESCRIPTION OF THE INVENTION

A remote communication system for communication with a companion animal (hereinafter abbreviated as a ‘remote communication system’) in accordance with an exemplary embodiment of the present invention is described in detail with reference to the accompanying drawings.

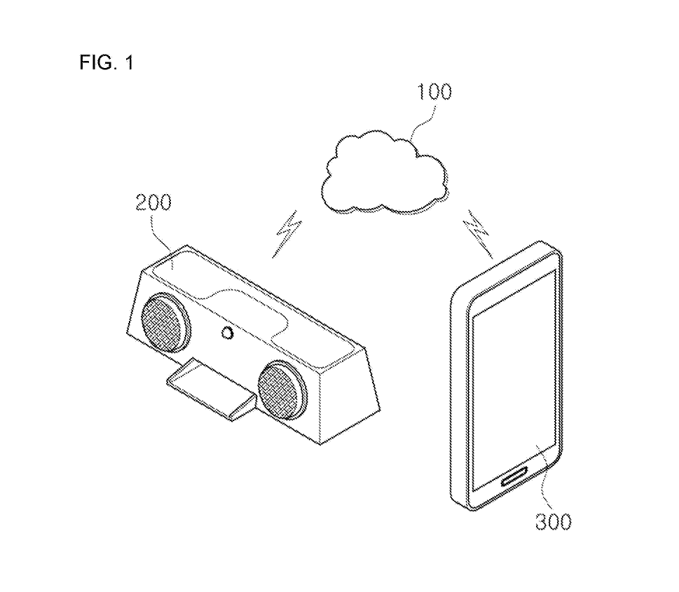

FIG. 1 shows the construction of a remote communication system in accordance with an embodiment of the present invention.

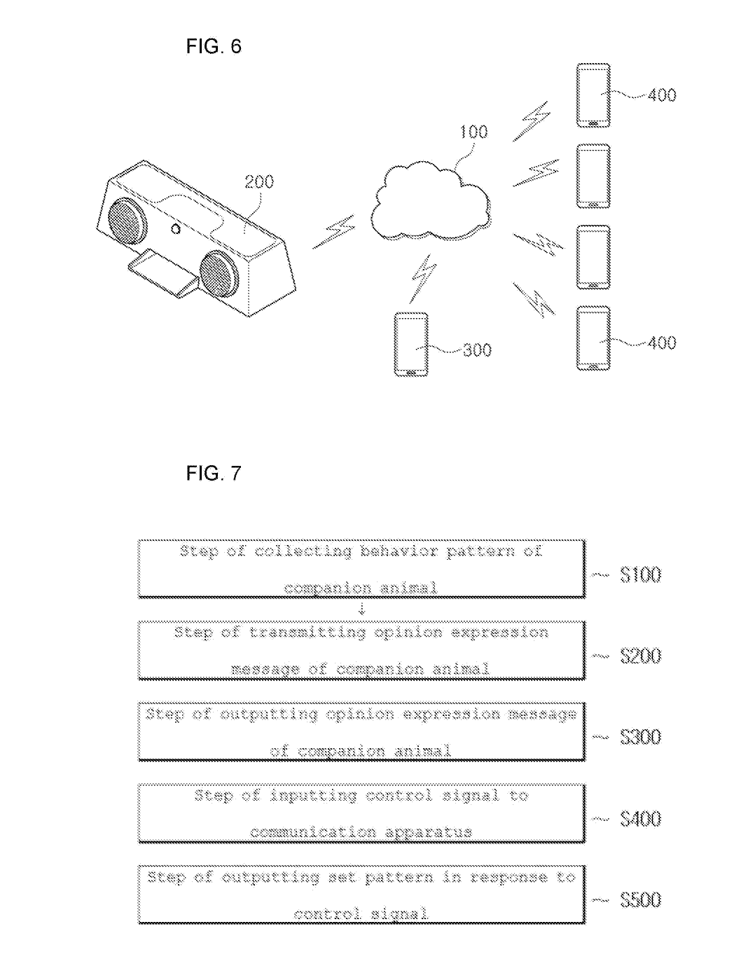

Referring to FIG. 1, the remote communication system according to the present invention includes a communication apparatus 200 for collecting information about a behavior pattern of a companion animal, analyzing the information about the behavior pattern, and transmitting a message configured based on the analyzed information over a wired/wireless network 100 and a user terminal 300 for receiving the message from the communication apparatus 200 over the wired/wireless network 100 and outputting the received message. The remote communication system may further include a supporter terminal 400 (refer to FIG. 6) for accessing the communication apparatus 200 based on authority for use that has been assigned by the communication apparatus 200.

In some embodiments, the user terminal 300 may be configured to transmit a message, collected by the user terminal 300, to the communication apparatus 200 over the wired/wireless network 100. Furthermore, the communication apparatus 200 may be configured to output a message received over the wired/wireless network 100. This is for performing bi-directional communication between a companion animal and a breeder at a remote place without transferring an intention of any one of the companion animal and the breeder to a counterpart in a unilateral direction.

Elements are described in detail below with reference to the accompanying drawings.

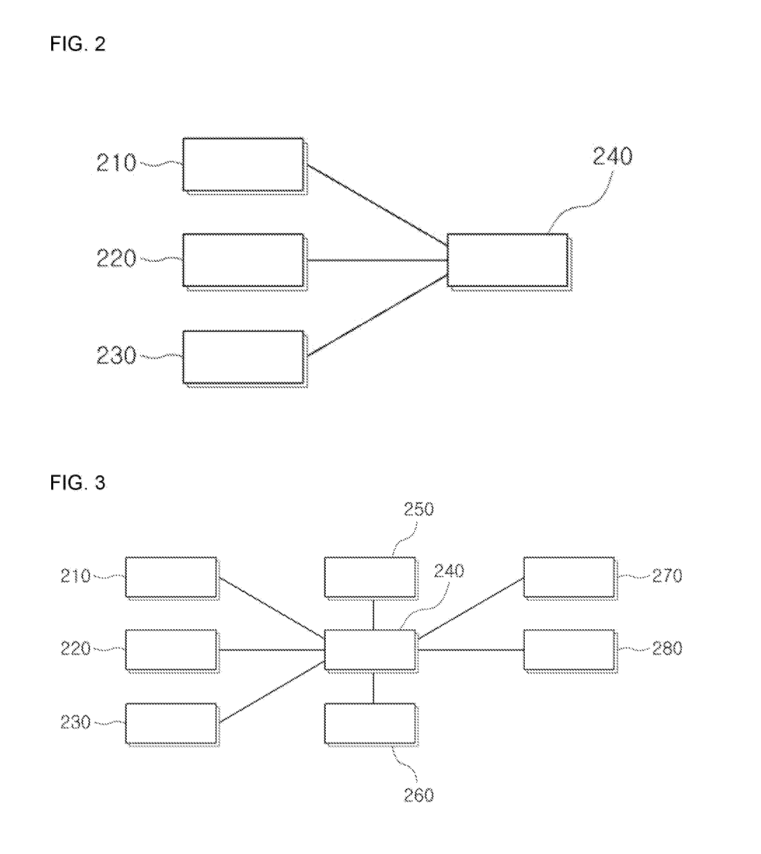

FIG. 2 is a block diagram of the communication apparatus 200 in accordance with an embodiment of the present invention.

Referring to FIGS. 1 and 2, the remote communication system according to the present invention includes the communication apparatus 200.

The communication apparatus 200 is connected to the wired/wireless network 100 and installed at a position close to a companion animal. The communication apparatus 200 functions to monitor behaviors of a companion animal, such as bark, lick, rub, press, bite, and tail shaking, in real time and collect information about behavior patterns of the companion animal.

Furthermore, the communication apparatus 200 functions to analyze the collected information about the behavior patterns, select a message to be provided to the user terminal 300 based on the analyzed information, and transmit the selected message to the user terminal 300 over the wired/wireless network 100.

To this end, as shown in FIG. 2, the communication apparatus 200 includes a sensor unit 210 for collecting information about behavior patterns of a companion animal, a storage unit 220 for storing opinion expression messages corresponding to the respective behavior patterns of the companion animal, a communication unit 230 for performing transmission and reception over the wired/wireless network 100, and a control unit 240 for confirming an opinion expression message for a companion animal by analyzing information about a behavior pattern collected by the sensor unit 210 based on an opinion expression message corresponding to the behavior pattern and providing the confirmed opinion expression message to the communication unit 230.

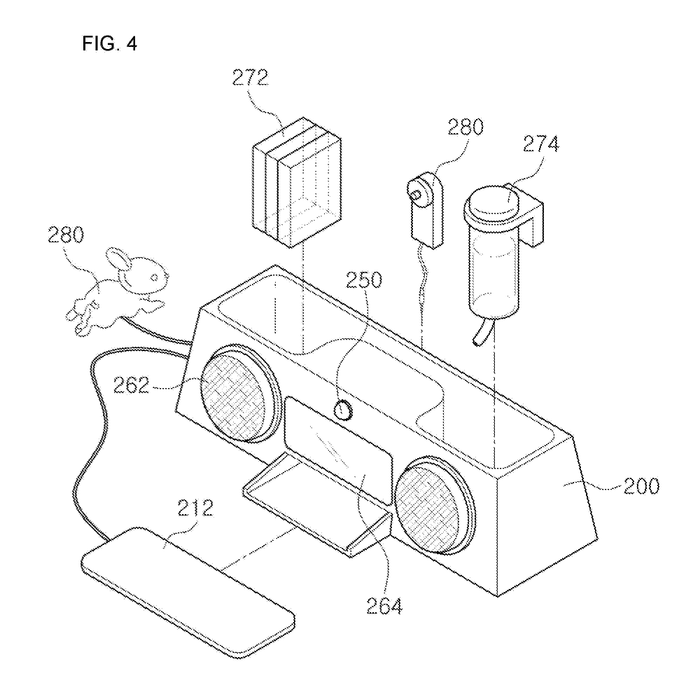

In some embodiments, as shown in FIGS. 3 and 4, the communication apparatus 200 according to the present invention may further include a camera unit 250 for capturing an image of a companion animal. The communication apparatus 200 of the present invention may further include output means 260 for outputting audio or video or both. The communication apparatus 200 of the present invention may further include a food supply device 270 or a play tool 280 or both which are connected to the control unit 240.

More particularly, the sensor unit 210 that forms the communication apparatus 200 of the present invention may be configured to include one or more sensors selected from the group consisting of a voice response sensor for sensing bark and cry, a torque sensor for sensing lick and bite, a touch sensor for sensing rub, a motion sensor for sensing tail shaking, a pressure sensor for sensing scratch and press, a displacement sensor for sensing watching, and a proximity sensor. In such a case, an opinion expression message that each companion animal wants to inform a breeder of the opinion expression message can be accurately checked by monitoring various behaviors of a companion animal and analyzing behavior patterns unique to the companion animal.

In another embodiment, the torque sensor, the touch sensor, and the pressure sensor according to the present invention may be installed in an input pad 212 connected to the control unit 240 as shown in FIG. 4.

The storage unit 220 that forms the communication apparatus 200 of the present invention may be configured to basically store common opinion expression messages corresponding to respective behavior patterns which are common to companion animals and selectively individual opinion expression messages corresponding to respective behavior patterns of each companion animal which have been inputted by a breeder who breeds the companion animal. This is because companion animals may express different meanings although their behaviors are the same.

Furthermore, if a common opinion expression message is different from an individual opinion expression message in relation to the same behavior pattern, priority is given to the individual opinion expression message.

As described above, the breeder of a companion animal checks that a behavior pattern of the companion animal includes what opinion expression message and stores information indicating that the behavior of the companion animal corresponds to what meaning in the communication apparatus 200.

When initial setting for the communication apparatus 200 is completed, a breeder can be provided with a correct message at a remote place through the communication apparatus 200 although a companion animal shows a behavior having a meaning different from a common meaning.

The communication unit 230 that forms the communication apparatus 200 of the present invention is connected to the user terminal 300 over the wired/wireless network 100 and configured to provide the user terminal 300 with opinion expression message converted by the control unit 240. Furthermore, the communication unit 230 receives a control signal from the user terminal 300 over the wired/wireless network 100 and provides the control signal to the control unit 240. Furthermore, the communication unit 230 provides a message to the supporter terminal 400 under the control of the control unit 240, receives a control signal from the supporter terminal 400, and provides the received control signal to the control unit 240.

The control unit 240 that forms the communication apparatus 200 of the present invention is connected to the sensor unit 210, the storage unit 220, and the communication unit 230 and configured to control the operations of the sensor unit 210, the storage unit 220, and the communication unit 230. For example, the control unit 240 stores information about a behavior pattern of a companion animal, collected by the sensor unit 210, in the storage unit 220 and derives the opinion expression message of a companion animal by analyzing the information about the behavior pattern based on an opinion expression message corresponding to the behavior pattern that has been stored in the storage unit 220.

Here, the opinion expression message of the companion animal that has been analyzed by the control unit 240 may be converted into a text message, a voice message, a video message, or a complex message including two or more of them in accordance with predetermined logic using a program stored in the storage unit 220 and then provided to the communication unit 230.

The opinion expression message of the companion animal, including such as a voice message, a video message, or a complex message, is transmitted by the control unit 240 in real time. In some embodiments, existing recorded data may be edited into data suitable for a situation according to communication with a companion animal through setting and then transmitted in real time.

Furthermore, when a message transmitted from the user terminal 300 to the communication unit 230 is received over the wired/wireless network 100, the control unit 240 outputs the message through the output means 260. For example, when video information or audio information provided by a breeder is received from the user terminal 300, the control unit 240 outputs the video information or the audio information.

Furthermore, when a control signal transmitted from the user terminal 300 to the communication unit 230 is received over the wired/wireless network 100, the control unit 240 analyzes the control signal and performs a control operation corresponding to the analyzed control signal. For example, when a breeder instructs to drive the food supply device 270, the play tool 280, or the camera unit 250 through the user terminal 300, the control unit 240 controls the food supply device 270, the play tool 280, or the camera unit 250 so that they are driven.

Furthermore, the control unit 240 may have the supporter terminal 400 with which a companion animal will be shared configured externally and store information about the configured supporter terminal 400 in the storage unit 220. Here, the configuration of the supporter terminal 400 with which a companion animal will be shared may be performed through the user terminal 300 over the wired/wireless network 100 or may be performed through the input interface of the communication apparatus 200.

Furthermore, when the supporter terminal 400 accesses the communication apparatus 200 over the wired/wireless network 100, the control unit 240 assigns access rights to the supporter terminal 400 by performing an authorization procedure. Here, the authorization procedure may be performed by inputting an ID and a password or may be performed using a method of comparing information about the supporter terminal 400 with which a companion animal will be shared, stored in the storage unit 220, with information (e.g., a telephone number) about the supporter terminal 400 that has accessed the communication apparatus 200.

In addition, when a message transmitted from the supporter terminal 400 having access rights assigned thereto to the communication unit 230 is received over the wired/wireless network 100, the control unit 240 outputs the message through the output means 260. Furthermore, when a control signal transmitted from the supporter terminal 400 having access rights assigned thereto to the communication unit 230 is received, the control unit 240 analyzes the control signal and performs a control operation corresponding to the analyzed control signal.

The camera unit 250 that forms the communication apparatus 200 of the present invention functions to collect images of a companion animal and sound generated from the companion animal. For example, a cam camera may be used as the camera unit 250. The camera unit 250 is connected to the control unit 240 and configured to capture images of a companion animal and collect sound generated from the companion animal under the control of the control unit 240.

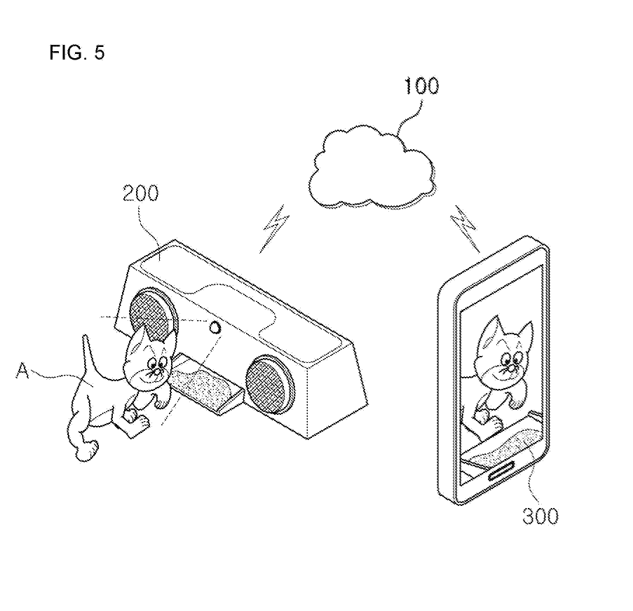

Furthermore, as shown in FIG. 5, the camera unit 250 can capture an image of a companion animal A who eats food and sends corresponding image data to the control unit 240 so that the image of the companion animal A who eats food can be checked through the user terminal 300. Here, the control unit 240 transmits the image data, received from the camera unit 250, to the user terminal 300 through the communication unit 230. In this case, a health state of a companion animal that is difficult to check through the sensor unit 210 can be checked through an image of the companion animal.

The output means 260 that forms the communication apparatus 200 of the present invention is connected to the control unit 240 and configured to output a message received from the user terminal 300. The output means 260 may be configured to include image output means 264 for outputting an image under the control of the control unit 240 or sound output means 262 for outputting sound under the control of the control unit 240 or both.

The food supply device 270 that forms the communication apparatus 200 of the present invention is connected to the control unit 240 and configured to supply food to a companion animal under the control of the control unit 240. The food supply device 270 may be configured to include a feed supply device 272 or a water supply device 274 or both.

In some embodiments, the food supply device 270 may further include an infrared sensor (not shown) for sensing the remaining amount in the feed supply device 272 or the water supply device 274 or both and sending corresponding information to the control unit 240.

Furthermore, the opening and shutting of the feed supply device 272 and the water supply device 274 of the food supply device 270 is controlled under the control of the control unit 240, and thus the feed supply device 272 and the water supply device 274 can automatically supply food and water to a companion animal on a predetermined time through timer setting. Here, the number of times that food or water is supplied and the time when food or water is supplied are accumulated as data, transmitted to the control unit 240 in real time, and stored in the storage unit 220. Furthermore, the number of times that food or water is supplied and the time when food or water is supplied can be controlled by setting the communication apparatus 200 or the user terminal 300.

The play tool 280 that forms the communication apparatus 200 of the present invention is provided for play with a companion animal. Any play tool 280 may be used if such an object can be achieved.

An integration type fixedly connected to the communication apparatus 200 can be used as the play tool 280, but a replacement type may be used so that a variety of the play tools 280 can be replaced or added. Furthermore, the play tool 280 can be remotely controlled by the user terminal 300 and can be attached and detached using the mounting groove of the communication apparatus 200.

The replacement type play tool 280 is connected through a connection terminal included in the communication apparatus 200, for example, a USB port and driven under the control of the control unit 240.

Furthermore, the time that the play tool 280 is driven can be recorded by the control unit 240 and stored in the storage unit 220.

Furthermore, information about the play tool 280 that operates in conjunction with the communication apparatus 200 can be collected by the control unit 240 and then provided to the user terminal 300. In this case, a breeder who is at a remote place can easily check that what play tool 280 has been connected to the communication apparatus 200 through the user terminal 300.

In some embodiments, the output means 260, the food supply device 270, and the play tool 280 may be connected to the control unit 240 wirelessly, for example, Bluetooth or ZigBee, and controlled remotely.

Referring to FIGS. 1 and 5, the remote communication system according to the present invention includes the user terminal 300.

The user terminal 300 is connected to the communication apparatus 200 over the wired/wireless network 100 and configured to output a message received from the communication apparatus 200. To this end, the user terminal 300 includes a monitor, such as an LCD or OLED, and a speaker.

The user terminal 300 refers to means capable of receiving a message over a wireless communication network, including a plurality of base stations, a base station controller, a mobile communication switchboard, and a WAP gateway, and a wired communication network, such as the Internet, and may be a mobile, a tablet PC, a PDA, a laptop, or a desktop.

In some embodiments, the user terminal 300 can transmit a message, such as image data or sound data collected by the user terminal 300, to the communication apparatus 200 over the wired/wireless network 100 so that bi-directional communication with the communication apparatus 200 can b performed. To this end, the user terminal 300 may be equipped with a camera and a microphone.

Furthermore, the user terminal 300 may be configured to have a remote control program installed therein so that the user terminal 300 can remotely control the communication apparatus 200 using a control signal received through the interface of the user terminal 300. To this end, the user terminal 300 may be equipped with an input interface, such as a touch pad.

The control signal may be an image capturing request signal that requests a real-time image of a companion animal to be captured and transmitted to the user terminal 300, a sound output request signal that requests a user's voice or a predetermined sound effect to be output as sound, or a supplementary request signal that requests any one of the feed supply device 272, the water supply device 274, and the play tool 280 embedded in the communication apparatus 200 to be driven.

More particularly, the user terminal 300 can control the camera unit 250 of the communication apparatus 200 so that the state of a companion animal can be checked in the form of a real-time image. Furthermore, the user terminal 300 may generate a control signal for a captured image so that the camera unit 250 captures an image of a companion animal and transmit the generated control signal to the communication apparatus 200.

Furthermore, the user terminal 300 can configure the supporter terminal 400 which can access the communication apparatus 200 through a remote control program and may set the range of rights of the accessed supporter terminal 400.

FIG. 6 shows the construction of a remote communication system in accordance with another embodiment of the present invention.

Referring to FIG. 6, the remote communication system according to the present invention includes one or more supporter terminals 400.

The supporter terminals 400 are provided so that persons other than the breeder of a companion animal can perform communication with the companion animal through the supporter terminals 400 and are connected to the communication apparatus 200 over the wired/wireless network 100.

The supporter terminal 400 may access the communication apparatus 200 through an application or may access the communication apparatus 200 by entering an Internet address.

Here, the communication apparatus 200 may request the supporter terminal 400 that has accessed the communication apparatus 200 over the wired/wireless network 100 to enter ID information in order to prevent a person who has not passed through an authorization procedure from using the communication apparatus 200.

For example, the communication apparatus 200 may request the supporter terminal 400 that has accessed the communication apparatus 200 over the wired/wireless network 100 to enter ID information, analyze the entered ID information, and provide the supporter terminal 400 with authority for use that has been assigned to the ID information.

In other words, the supporter terminal 400 enters ID information to the communication apparatus 200 that has been accessed over the wired/wireless network 100, and in response thereto, authority for use is assigned to the supporter terminal 400. The ID information may include one or more of a resident registration number, an address, a telephone number, an ID for login, and a password of a supporter.

The supporter terminal 400 may be a mobile, a tablet PC, a PDA, a laptop, or a desktop.

If a veterinarian uses the supporter terminal 400, the health state of a companion animal can be checked although the breeder of the companion animal does not take the companion animal to an animal hospital.

Furthermore, if a preliminary breeder who wants to breed a companion animal uses the supporter terminal 400, the preliminary breeder (e.g., an animal hospital or an animal rescue center) can increase the degree of intimacy with a pet animal before fostering because the preliminary breeder can arrange feelings of intimacy, such as watching, speaking, and playing, with the pen animal.

A remote communication method with a companion animal using the remote communication system including the aforementioned elements is described below.

FIG. 7 is a flowchart illustrating a remote communication method with a companion animal in accordance with an embodiment of the present invention.

Referring to FIG. 7, the remote communication method of the present invention includes a behavior pattern collection step S100 of collecting, by the communication apparatus 200, information about a behavior pattern of a companion animal by sensing the behavior pattern, a message transmission step S200 of generating, by the communication apparatus 200, a message by analyzing the information about the behavior pattern and transmitting the generated message to the user terminal 300 over the wired/wireless network 100, and a message output step S300 of outputting, by the user terminal 300, the message received from the communication apparatus 200 over the wired/wireless network 100.

More particularly, at the behavior pattern collection step S100 according to the present invention, first, the sensor unit 210 of the communication apparatus 200 disposed at a position close to a companion animal performs a process of collecting information about a behavior pattern of the companion animal by sensing a behavior, such as bark, cry, lick, rub, bite, tail shaking, scratch, or press that is a communication method of the companion animal, in real time.

The sensor unit 210 performs a process of providing the control unit 240 with the collected information about the behavior pattern of the companion animal.

At the message transmission step S200 according to the present invention, the control unit 240 of the communication apparatus 200 performs a process of confirming an opinion expression message of the companion animal by analyzing the information about the behavior pattern based on the opinion expression message of the companion animal for each behavior pattern stored in the storage unit 220 and converting the confirmed opinion expression message of the companion animal into a set message, such as a text message, a video message, or a sound message. The conversion of the opinion expression message of the companion animal is performed in accordance with the predetermined logic of a program that is stored in the storage unit 220.

The control unit 240 performs a process of providing the converted set message to the communication unit 230, and the communication unit 230 performs a process of providing the set message to the user terminal 300 over the wired/wireless network 100.

At the message output step S300 according to the present invention, the user terminal 300 performs a process of outputting the set message, received from the communication apparatus 200 over the wired/wireless network 100, through an output device, such as a monitor or a speaker.

In some embodiments, the remote communication method according to the present invention may further include a control step S400 of accessing, by the user terminal 300, the communication apparatus 200 over the wired/wireless network 100 and inputting a control signal to the communication apparatus 200 and a pattern output step S500 of outputting, by the communication apparatus 200, a set pattern in response to the control signal.

At the control step S400, the camera unit 250 of the communication apparatus 200 may be requested to capture an image of the companion animal so that an image of the companion animal can be checked in real time through the monitor of the user terminal 300.

Furthermore, at the control step S400, the user terminal 300 may request the communication apparatus 200 to output specific sound so that a breeder's voice or a sound effect to which the companion animal responds is output through the speaker of the communication apparatus 200.

Furthermore, at the control step S400, the user terminal 300 may request the communication apparatus 200 to drive additional devices so that the food supply device 270 or the play tool 280 embedded in the communication apparatus 200 can be driven.

Meanwhile, the remote communication method with a companion animal according to the present invention may further include a supporter configuration step of receiving, by the communication apparatus, information about the supporter terminal with which a companion animal will be shared.

In an embodiment, the present invention may include a supporter configuration step of receiving, by the communication apparatus, information about the supporter terminal with which a companion animal will be shared, a behavior pattern collection step of collecting, by the communication apparatus, information about a behavior pattern of the companion animal by sensing a behavior of the companion animal, a message transmission step of confirming, by the communication apparatus, an opinion expression message of the companion animal by analyzing the information about the behavior pattern and transmitting the confirmed opinion expression message to the user terminal or the supporter terminal or both over the wired/wireless network, and a message output step of outputting, by the user terminal or the supporter terminal or both, the opinion expression message received from the communication apparatus over the wired/wireless network.

In such a communication method, multilateral communication with a companion animal can be performed by configuring the supporter terminal with which information about the companion animal will be shared in the communication apparatus in advance and providing an opinion expression message of the companion animal to the user terminal owned by a breeder or the supporter terminal of an acquaintance designated by the breeder or both.

In another embodiment, the present invention may include a supporter configuration step of receiving, by the communication apparatus, information about the supporter terminal with which a companion animal will be shared, an auxiliary control step of accessing, by the supporter terminal, the communication apparatus over the wired/wireless network and inputting a control signal to the communication apparatus, and an auxiliary pattern output step of outputting, by the communication apparatus, a set pattern in response to the control signal.

In such a communication method, a burden of the fostering of a breeder can be reduced because an acquaintance designated by the breeder can perform feeding, playing, and communication for an animal through the supporter terminal instead of the breeder.

Furthermore, a substantial help can be provided to a silver household who has no knowledge of the fostering of a companion animal through the sharing of information about the companion animal because many people can share several pieces of information about the fostering of the companion animal.

Furthermore, if the communication method is used in an animal hospital or an animal rescue center, the user of the supporter terminal can select a desired type of a companion animal because the user can increase the degree of intimacy before fostering by performing behaviors, such as facing each other, speaking, and feeding, with a pet animal remotely.

If the remote communication system according to the present invention is used, there is an advantage in that a companion animal can be monitored at a close distance even at a remote place because information about a behavior pattern of the companion animal can be provided through the Internet.

Furthermore, the fostering of a companion animal at a remote place and the increase of intimacy with the companion animal can be performed using a mobile and a tablet PC as well as a computer.

Furthermore, if the remote communication system according to the present invention is used, a burden of the fostering of a breeder can be reduced because feeding, playing, and communication for a companion animal can be performed even at a remote place.

Furthermore, in accordance with the present invention, a substantial help can be provided to a silver household who has no knowledge of the fostering of a companion animal through the sharing of several pieces of information about the fostering of the companion animal because many people share information about the companion animal through the setting of access rights. In addition, sociality between a companion animal and people can be enhanced.

If the system capable of sharing a companion animal is constructed as described above, more curiosity and interests to companion animals can be induced, and a new culture for companion animals can be created because a dignity value of life can be informed by assigning a value of a companion animal that is naturally formed.

Furthermore, although a companion animal is lost, other persons' mobile phones according to the present invention can be immediately notified of the lost companion animal through stored images or videos for the lost companion animal. Furthermore, persons who already share the companion animal can easily notice and find the lost companion animal because they have already known the lost companion animal.

Furthermore, if the remote communication system according to the present invention is installed in an animal hospital and an animal rescue center, people who want to foster companion animals can select desired types of companion animal because they can increase the degree of intimacy before directly fostering animals by performing behaviors, such as facing each other, speaking, and feeding, with pet animals in a variety of animal hospitals and animal care centers remotely. Furthermore, satisfactions for the fostering of companion animals may be maximized.

In this case, animal hospitals can promote the selling of pet animals, and animal rescue center can promote the adoption of abandoned pet animals.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A remote communication system with a companion animal, comprising:
a communication apparatus for collecting information about a behavior pattern of the companion animal and transmitting a message, configured by analyzing the collected information, over a wired/wireless network; and
a user terminal for receiving the message received from the communication apparatus over the wired/wireless network and outputting the received message.

2. The remote communication system of claim 1, wherein the communication apparatus comprises:
a sensor unit for collecting information about a behavior pattern of the companion animal;
a storage unit for storing opinion expression messages corresponding to respective behavior patterns of the companion animal;
a communication unit for performing transmission and reception over the wired/wireless network; and
a control unit for confirming an opinion expression message corresponding to information about a behavior pattern by analyzing the information about the behavior pattern, collected by the sensor unit, based on the opinion expression messages corresponding to the respective behavior patterns and providing the confirmed opinion expression message to the communication unit.

3. The remote communication system of claim 2, wherein the sensor unit comprises one or more sensors selected from a group consisting of a voice response sensor, a torque sensor, a touch sensor, a motion sensor, a pressure sensor, a displacement sensor, and a proximity sensor.

4. The remote communication system of claim 2, further comprising an infrared sensor for sensing a remaining amount in a feed supply device, a water supply device, or both the feed supply device and the water supply device and transmitting information about the remaining amount to the control unit.

5. The remote communication system of claim 1, wherein:
the user terminal transmits a message, collected by the user terminal, to the communication apparatus over the wired/wireless network, and
the communication apparatus outputs the message received over the wired/wireless network.

6. The remote communication system of claim 1, wherein the user terminal has a remote control program installed therein and remotely controls the communication apparatus using a control signal received through an interface installed in the user terminal.

7. The remote communication system of claim 1, wherein the opinion expression message of the companion animal stored in the storage unit comprises a text message, a voice message, a video message, or a complex message comprising two or more of the text message, the voice message, and the video message.

8. The remote communication system of claim 1, further comprising a supporter terminal for accessing the communication apparatus over the wired/wireless network and for being assigned authority for use by entering an ID and a password.

9. A remote communication method with a companion animal, comprising:
a behavior pattern collection step of collecting, by a communication apparatus, information about a behavior pattern of the companion animal by sensing the behavior pattern;
a message transmission step of generating, by the communication apparatus, an opinion expression message of the companion animal by analyzing the information about the behavior pattern and transmitting the generated opinion expression message to a user terminal over a wired/wireless network; and
an message output step of outputting, by the user terminal, the opinion expression message received from the communication apparatus over the wired/wireless network.

10. The remote communication method of claim 9, further comprising:
a control step of accessing, by the user terminal, the communication apparatus over the wired/wireless network and inputting a control signal to the communication apparatus; and
a pattern output step of outputting, by the communication apparatus, a set pattern in response to the control signal.

11. A remote communication method with a companion animal, comprising:
a supporter configuration step of receiving, by a communication apparatus, information about a supporter terminal with which the companion animal is to be shared;
a behavior pattern collection step of collecting, by the communication apparatus, information about a behavior pattern of the companion animal by sensing a behavior of the companion animal;
a message transmission step of confirming, by the communication apparatus, an opinion expression message of the companion animal by analyzing the information about the behavior pattern and transmitting the confirmed opinion expression message to a user terminal, the supporter terminal, or both the user terminal and the supporter terminal over a wired/wireless network; and
a message output step of outputting, by the user terminal or the supporter terminal or both the user terminal and the supporter terminal, the opinion expression message received from the communication apparatus over the wired/wireless network.

12. A remote communication method with a companion animal, comprising:
a supporter configuration step of receiving, by a communication apparatus, information about a supporter terminal with which a companion animal is to be shared;
an auxiliary control step of accessing, by the supporter terminal, the communication apparatus over a wired/wireless network and inputting a control signal to the communication apparatus; and
an auxiliary pattern output step of outputting, by the communication apparatus, a set pattern in response to the control signal.
